(19) United States
(12) Patent Application Publication
(10) Pub. No.: US 2025/0246647 A1
(43) Pub. Date: Jul. 31, 2025

(54) MEMBRANE ELECTRODE STRUCTURE FOR FUEL CELL AND FUEL CELL SYSTEM

(71) Applicant: Honda Motor Co., Ltd.

(72) Inventor: Shunsuke Nishijima, Saitama (JP)

(21) Appl. No.: 19/032,577

(22) Filed: Jan. 21, 2025

(30) Foreign Application Priority Data
Jan. 31, 2024 (JP) 2024-013336

(51) Int. Cl. H01M 8/0273; H01M 8/0267; H01M 8/0276; H01M 8/04119; H01M 8/1004; H01M 8/1007

(52) U.S. Cl. CPC H01M 8/0273; H01M 8/0267; H01M 8/0276; H01M 8/04126; H01M 8/1004; H01M 8/1007

(57) ABSTRACT

A membrane electrode structure for fuel cell including a membrane electrode assembly including an electrolyte membrane, and a frame member including an inner edge portion defining an opening, the membrane electrode assembly being positioned to face the opening. The frame member includes a first and second frame members formed in a substantially plate shape and overlapping each other, the electrolyte membrane is extended to non-power generation region, the first and second frame members have a first and second holding portions between which the electrolyte membrane in the non-power generation region is sandwiched, and a first through-hole penetrating the first holding portion and a second through-hole penetrating the second holding portion are provided at different positions from each other in a plan view viewed along a stacking direction of the membrane electrode structure.

### CROSS-REFERENCE TO RELATED APPLICATION

This application is based upon and claims the benefit of priority from Japanese Patent Application No. 2024-013336 filed on Jan. 31, 2024, the content of which is incorporated herein by reference.

### BACKGROUND OF THE INVENTION

### Field of the Invention

This invention relates to a membrane electrode structure for fuel cell and a fuel cell system.

### Description of the Related Art

In recent years, technological developments have been made on a fuel cell that contribute to energy efficiency in order to ensure access to energy that is affordable, reliable, sustainable and advanced by more people. As a conventional technology related to a power generation cell used in this type of fuel cell, there is a known power generation cell which is configured to exchange humidity of gases on the anode and cathode sides outside the power generation area. Such a power generation cell is described, for example, in Japanese Unexamined Patent Publication No. 2017-183031 (JP 2017-183031 A). In the power generation cell described in JP 2017-183031 A, a substantially plate-shaped resin frame is placed around the cathode side gas diffusion layer to overlap the anode side gas diffusion layer, a plurality of through-holes are provided in the resin frame, and a membrane electrode structure is configured so that the humidity of gases on the anode and cathode sides is exchanged through these through-holes.

However, as described in JP 2017-183031 A, providing a plurality of through-holes in the resin frame for humidity exchange reduces the strength of the resin frame, making it difficult to achieve sufficient durability.

### SUMMARY OF THE INVENTION

An aspect of the present invention is a membrane electrode structure for a fuel cell including: a membrane electrode assembly including an electrolyte membrane, a first gas diffusion electrode layer provide on a first surface of the electrolyte membrane, and a second gas diffusion electrode layer provided on a second surface of the electrolyte membrane opposite to the first surface, the electrolyte membrane, the first gas diffusion electrode layer and the second gas diffusion electrode layer being stacked in a predetermined direction; and a frame member including an inner edge portion defining an opening, the membrane electrode assembly being positioned to face the opening. The frame member includes a first frame member and a second frame member formed in a substantially plate shape and overlapping each other, each of the first frame member and the second frame member includes the inner edge portion, the electrolyte membrane is extended to a non-power generation region outside an outer edge of the first gas diffusion electrode layer and outside an outer edge of the second gas diffusion electrode layer, the first frame member and the second frame member have a first holding portion and a second holding portion, respectively, so as to sandwich the electrolyte membrane in the non-power generation region between the first holding portion and the second holding portion, a first through-hole and a second through-hole are provided to penetrate the first holding portion and the second holding portion, respectively, and a position of the first through-hole is different from a position of the second through-hole in a plan view when viewed along the predetermined direction.

### BRIEF DESCRIPTION OF THE DRAWINGS

The objects, features, and advantages of the present invention will become clearer from the following description of embodiments in relation to the attached drawings, in which:

FIG. 1 is a view schematically illustrating a main configuration of a fuel cell system according to an embodiment of the present invention;

FIG. 2 is a perspective view schematically illustrating an overall configuration of a fuel cell stack included in the fuel cell system in FIG. 1;

FIG. 3 is a cross-sectional view taken along line III-III in FIG. 2;

FIG. 4 is a perspective view schematically illustrating a configuration of a unitized electrode assembly included in the fuel cell stack in FIG. 2;

FIG. 5A is a rear view of a separator included in the fuel cell stack in FIG. 2;

FIG. 5B is a front view of a separator included in the fuel cell stack in FIG. 2;

FIG. 6 is cross-sectional view taken along line VI-VI in FIG. 4;

FIG. 7A is a view taken along an arrow VII in FIG. 4;

FIG. 7B is a view illustrating a modification of FIG. 7A;

FIG. 8A is a view illustrating a modification of FIG. 4;

FIG. 8B is a view illustrating another modification of FIG. 4;

FIG. 9 is a view illustrating further other modification of FIG. 4;

FIG. 10 is a view illustrating a modification of FIG. 5A; and

FIG. 11 is a rear view of the unitized electrode assembly facing the separator in FIG. 10.

### DETAILED DESCRIPTION OF THE INVENTION

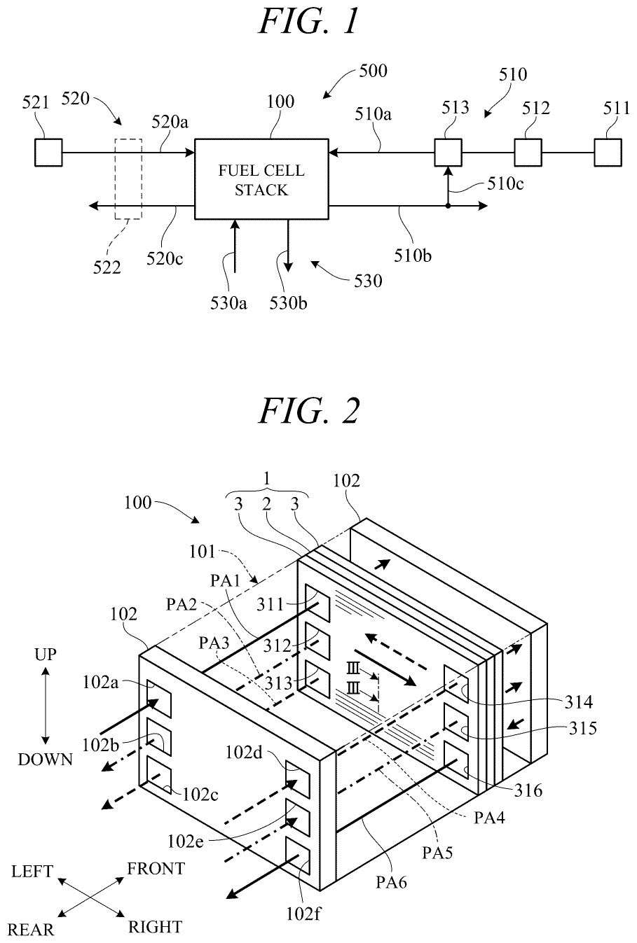

Hereinafter, an embodiment of the present invention will be described with reference to FIGS. 1 to 11. FIG. 1 is a block diagram schematically illustrating a configuration of a main part of a fuel cell system 500 according to an embodiment of the present invention. The fuel cell system 500 is mounted on a vehicle, for example, and generates electric power for driving the vehicle. As illustrated in FIG. 1, the fuel cell system 500 includes a fuel cell stack 100 formed by stacking a plurality of power generation cells, a fuel gas supply/discharge part 510, an oxidant gas supply/discharge part 520, and a cooling medium supply/discharge part 530. A fuel gas and an oxidant gas may also be referred to as an anode gas and a cathode gas, respectively.

The fuel gas supply/discharge part 510 includes a tank 511 that stores a high-pressure fuel gas, an injector 512 that injects the fuel gas, and an ejector 513. The fuel gas in the tank 511 is supplied to the fuel cell stack 100 via the injector 512, the ejector 513, and a supply flow path 510a. The fuel gas is an anode gas (for example, hydrogen gas) containing hydrogen. A fuel gas (fuel exhaust gas) containing moisture is discharged from the fuel cell stack 100 through a discharge flow path 510b. In the ejector 513, the fuel exhaust gas is sucked through a circulation flow path 510c by a negative pressure generated by the flow of the fuel gas injected from the injector 512. Accordingly, the fuel gas is returned to the fuel cell stack 100. Although not illustrated, a gas-liquid separator is provided in the discharge flow path 510b, and excess moisture contained in the fuel exhaust gas is removed by the gas-liquid separator.

The oxidant gas supply/discharge part 520 includes a compressor 521 that compresses the oxidant gas to a high pressure. The oxidant gas compressed by the compressor 521 is supplied to the fuel cell stack 100 through a supply flow path 520a. The oxidant gas is a cathode gas (for example, air) containing oxygen. An oxidant gas (oxidant exhaust gas) containing moisture is discharged from the fuel cell stack 100 through a discharge flow path 520b. A humidifier 522 (dotted line) that humidifies the oxidant gas may be provided in the middle of the supply flow path 520a. However, in the present embodiment, humidification of the oxidant gas is promoted as described later, so that the humidifier 522 can be omitted.

The cooling medium supply/discharge part 530 includes a pump (not illustrated), and a cooling medium discharged from the pump is supplied to the fuel cell stack 100 via a supply flow path 530a. The cooling medium is, for example, water. The cooling medium is discharged from the fuel cell stack 100 through a discharge flow path 530b. The discharged cooling medium is cooled by heat exchange in a radiator, and is supplied to the fuel cell stack 100 again via the supply flow path 530a.

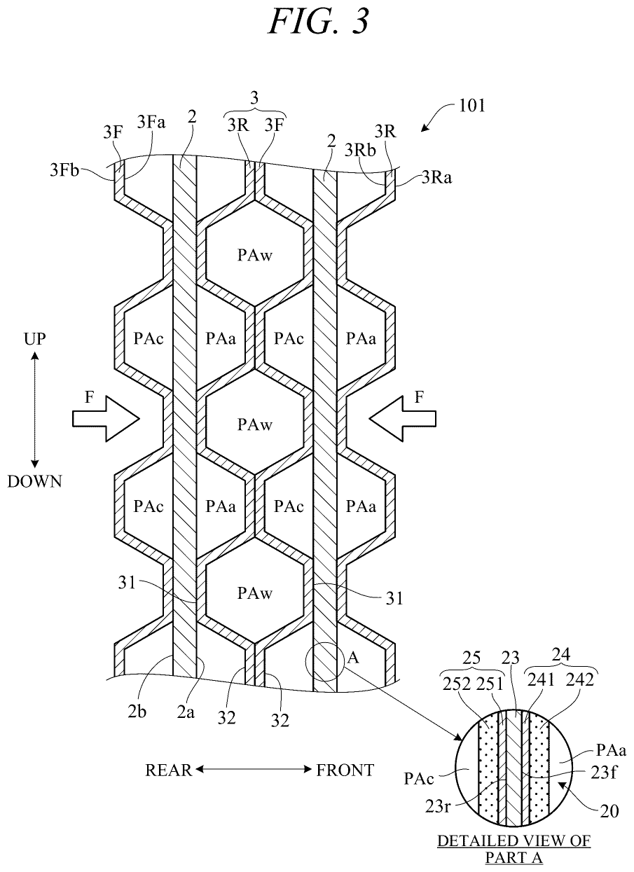

FIG. 2 is a perspective view schematically showing an overall configuration of the fuel cell stack 100. Hereinafter, for the sake of convenience, three-axis directions orthogonal to each other as illustrated in the drawing are defined as a front-rear direction, a left-right direction, and an up-down direction, and a configuration of each part will be described according to such definitions. These directions are not necessarily the same as the front-rear direction, left-right direction and up-down direction of the vehicle. For example, the front-rear direction in FIG. 2 may be the front-rear direction, the left-right direction or the up-down direction of the vehicle.

As shown in FIG. 2, the fuel cell stack 100 has a cell stacked body 101 formed by stacking a plurality of power generation cells 1 in the front-rear direction, and end units 102 arranged at both ends in the front-rear direction of the cell stacked body 101, and the whole of the fuel cell stack 100 has a substantially rectangular parallelepiped shape. Although not shown, a substantially box-shaped case with open front and rear faces is arranged around the cell stacked body 101. The front end surface of the case and the front end unit 102, as well as the rear end surface of the case and the rear end unit 102, are fastened together with bolts.

The power generation cell 1 has a unitized electrode assembly (hereinafter, referred to as a “UEA”) 2 including a joint body (a membrane electrode assembly) that includes an electrolyte membrane and electrodes, and a pair of front and rear separators 3 and 3 arranged on both sides in the front-rear direction of the UEA 2 to sandwich the UEA 2. The UEA 2 and the separator 3 are alternately arranged in the front-rear direction. A membrane electrode structure is configured by the UEA 2. The UEA 2 can also be referred to as a membrane electrode member.

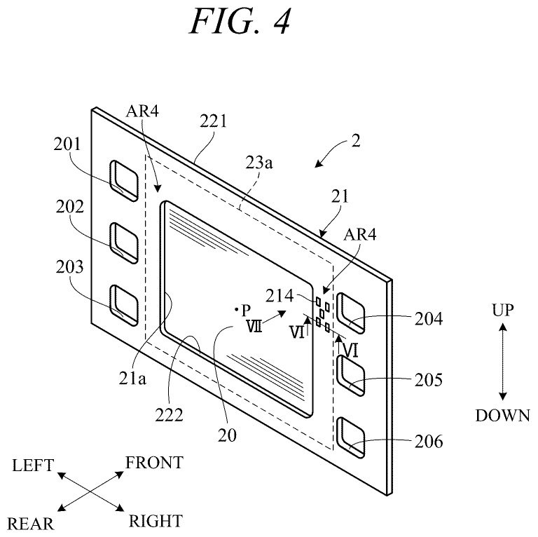

FIG. 3 is a cross-sectional view at the central portion in the left-right direction of a main part of the cell stacked body 101 (cross-sectional view taken along line III-III in FIG. 2). As shown in FIG. 3, the separator 3 has a front plate 3F and a rear plate 3R, which are a pair of metal thin plates with a corrugated cross-section. The front plate 3F extends in the up-down and left-right directions and has a front surface 3Fa and a rear surface 3Fb. The rear plate 3R extends in the up-down, and left-right directions, and has a front surface 3Ra and a rear surface 3Rb. The rear surface 3Fb of the front plate 3F and the front surface 3Ra of the rear plate 3R facing each other are joined together by welding or the like at their outer peripheral edges. Thus, the front plate 3F and the rear plate 3R are integrally joined. The separator 3 uses a conductive material with excellent corrosion resistance, such as stainless steel, titanium, or titanium alloy.

Inside the separator 3 enclosed by the front plate 3F and the rear plate 3R, that is, between the rear surface 3Fb of the front plate 3F and the front surface 3Ra of the rear plate 3R, a cooling medium flow path PAw through which a cooling medium flows is formed. The generating surface of the power generation cell 1 is cooled by the flow of the cooling medium. The surfaces of the separator 3 facing the UEA 2 (front surface 3Fa and the rear surface 3Rb) are formed into an uneven shape by press molding or the like to form a gas flow path between the separator 3 and the UEA 2. More specifically, the front plate 3F and the rear plate 3R have convex portions 31 protruding towards the front and rear UEA 2, and concave portions 32 concavely formed in continuation to the convex portions 31.

The rear convex portion 31 contacts the front surface 2a of the UEA 2 and the front convex portion 31 contacts the rear surface 2b of the UEA 2. In the cell stacked body 101, a compressive load F is applied in the front-rear direction during the assembly of the fuel cell stack 100, and in this state, the case surrounding the cell stacked body 101 and the front and rear end units 102 are fastened. Therefore, after the assembly of the fuel cell stack 100 is completed, the compressive load F on the fuel cell stack 100 is maintained, and a predetermined surface pressure acts on the UEA 2 in the front-rear direction through the convex portions 31.

Between the front surface 2a of the UEA 2 and the rear plate 3R of the separator 3 facing this front surface 2a, an anode flow path PAa through which fuel gas flows is formed by the concave portion 32. Between the rear surface 2b of the UEA 2 and the front plate 3F of the separator 3 facing this rear surface 2b, a cathode flow path PAc through which oxidant gas flows is formed by the concave portion 32. The fuel gas and oxidant gas may collectively be referred to as a reaction gas without distinguishing between them.

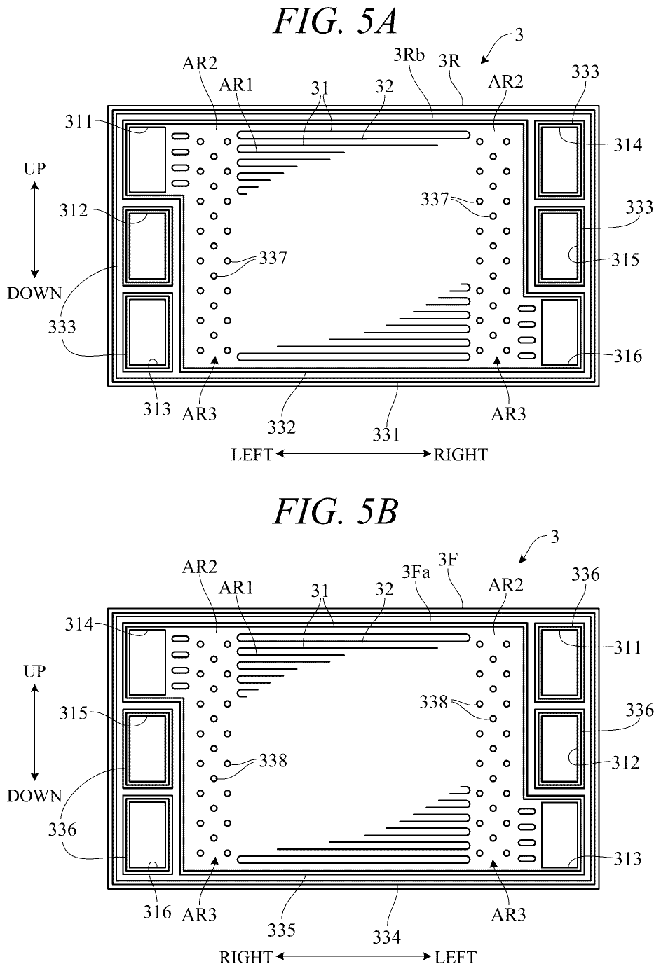

FIG. 4 is a perspective view showing a schematic configuration of the UEA 2. As shown in FIG. 4, the UEA 2 includes a substantially rectangular membrane electrode assembly 20 (hereinafter, referred to as a “MEA”) and a frame 21 that supports the MEA 20. As shown in the detailed view of part “A” in FIG. 3, the MEA 20 has an electrolyte membrane 23, an anode electrode 24 provided on a front surface 231 of the electrolyte membrane 23, and a cathode electrode 25 provided on a rear surface 232 of the electrolyte membrane 23.

The electrolyte membrane 23 is, for example, a solid polymer electrolyte membrane, and a thin film of perfluorosulfonic acid polymer containing moisture can be used. Not only a fluorine-based electrolyte but also a hydrocarbon-based electrolyte can be used.

The anode electrode 24 has an electrode catalyst layer 241 formed on the front surface 23f of the electrolyte membrane 23 and served as a reaction field for electrode reaction, and a gas diffusion layer 242 formed on the front surface of the electrode catalyst layer 241 to spread and supply the fuel gas. The cathode electrode 25 has an electrode catalyst layer 251 formed on the rear surface 23r of the electrolyte membrane 23 and served as a reaction field for electrode reaction, and a gas diffusion layer 252 formed on the rear surface of the electrode catalyst layer 251 to spread and supply the oxidant gas. An intermediate layer (underlayer) can also be provided between the electrode catalyst layer 241 and the gas diffusion layer 242. An intermediate layer (underlayer) can also be provided between the electrode catalyst layer 251 and the gas diffusion layer 252.

The electrode catalyst layers 241 and 251 include a catalyst metal that promotes the electrochemical reaction of hydrogen contained in the fuel gas and oxygen contained in the oxidant gas, an electrolyte (such as an ionomer) with proton conductivity, and carbon particles with electron conductivity, and the like. The gas diffusion layers 242 and 252 are made of conductive members with gas permeability, such as carbon porous bodies.

In the anode electrode 24, the fuel gas (hydrogen) supplied through the anode flow path PAa is ionized by an action of a catalyst, passes through the electrolyte membrane 23, and moves to the cathode electrode side. Electrons generated at this time pass through an external circuit and are extracted as electric energy. In the cathode electrode 25, an oxidant gas (oxygen) supplied via the cathode flow path PAc reacts with hydrogen ions guided from the anode electrode 24 and electrons moved from the anode electrode 24 to generate water. The generated water gives an appropriate humidity to the electrolyte membrane 23, and excess water is discharged to an outside of the UEA 2 along the gas flow. The generated water on the cathode side also flows to the anode side via the electrolyte membrane 23 by inverse diffusion. Therefore, both the fuel gas and the oxidant gas contain the generated water. The fuel gas and oxidant gas also contain condensed water.

As illustrated in FIG. 4, the frame 21 is a thin plate having a substantially rectangular shape, and is made of resin, rubber, or the like having insulating properties and gas impermeability. As an example, polyethylene naphthalate (PEN), polyphenylene sulfide (PPS), or the like can be used as a constituent material. A substantially rectangular opening 21a is formed in a central portion of the frame 21, and the MEA 20 is provided so as to cover the entire opening 21a. The frame 21 has an outer edge portion 221 and an inner edge portion 222 which have substantially rectangular shapes. The outer edge portion 221 refers to the outer edge of the frame 21 and the peripheral portion thereof, and the inner edge portion 222 refers to the inner edge of the frame 21 (the edge of the opening 21a) and the peripheral portion thereof.

A point P in FIG. 4 is a center point passing through the middle of the opening 21a in the up-down direction and the left-and direction. On the left side of the opening 21a of the frame 21, three through-holes 201 to 203 penetrating the frame 21 in the front-rear direction are opened side by side in the up-down direction. On the right side of the opening 21a, three through-holes 204 to 206 penetrating the frame 21 in the front-rear direction are opened side by side in the up-down direction. Each of the through-holes 201 to 206 is illustrated as a substantially rectangular shape for convenience, but the shape and arrangement of the through-holes 201 to 206 are not limited thereto.

As shown in FIG. 2, in the separator 3 in front of and behind the UEA 2, through-holes 311 to 316 penetrating the separators 3 in the front-rear direction are opened at positions corresponding to the through-holes 201 to 206 of the frame 21. The through-holes 311 to 316 communicate with the through-holes 201 to 206 of the frame 21, respectively. The set of the through-holes 201 to 206 and 311 to 316 communicating with each other forms flow paths PA1 to PA6 (indicated by arrows for the sake of convenience) penetrating the cell stacked body 101 and extending in the front-rear direction. The flow paths PA1 to PA6 may be referred to as manifolds. The flow paths PA1 to PA6 are connected to a manifold outside the fuel cell stack 100.

Although not shown, the front and rear end units 102 of the cell stacked body 101 each have multiple plates that are arranged to overlap in the front-rear direction. Specifically, the end unit 102 includes a terminal plate arranged adjacent to the cell stacked body 101, an insulating plate arranged outside the terminal plate in the front-rear direction, and an end plate arranged outside the insulating plate in the front-rear direction.

The terminal plate is a substantially rectangular metal plate member and has a terminal portion for extracting power generated by electrochemical reactions in the cell stacked body 101. The insulating plate is a substantially rectangular plate member made of non-conductive resin or rubber, and electrically insulates the terminal plate and the end plate. The end plate is a plate member made of metal or high-strength resin.

The rear end unit 102 is a wet-side end unit through which a reaction gas and cooling medium pass, and the front end unit 102 is a dry-side end unit through which the reaction gases and cooling medium do not pass. In the rear end unit 102, a plurality of through-holes 102a to 102f, which penetrate the end unit 102 in the front-rear direction, are opened at positions corresponding to the through-holes 201 to 206 and 311 to 316 of the cell stacked body 101. The through-holes 102a to 102f are shown as substantially rectangular for convenience, but the shapes of the through-holes 102a to 102f are not limited to this.

The flow paths PA1 and PA6 (solid arrows) are flow paths for supplying and discharging the fuel gas, respectively, and the supply flow path 510a and the discharge flow path 510b in FIG. 1 are connected to the through-holes 311, 201 and 316, 206, respectively. The flow paths PA4 and PA3 (dotted arrows) are flow paths for supplying and discharging the oxidant gas, respectively, and the supply flow path 520a and the discharge flow path 520b in FIG. 1 are connected to the through-holes 314, 204 and 313, 203, respectively. The flow paths PA5 and PA2 (dashed-dotted arrows) are flow paths for supplying and discharging the cooling medium, respectively, the supply flow path 530a and the discharge flow path 530b in FIG. 1 are connected to the through-holes 315, 205, and 312, 202, respectively.

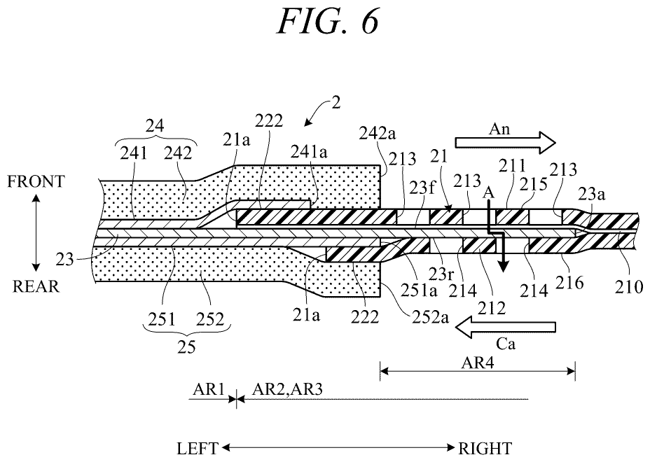

The configuration of the separator 3 will be described in more detail. FIG. 5A is a rear view (a view viewed from the rear) of the separator 3, and FIG. 5B is a front view (a view viewed from the front) thereof. That is, FIG. 5A is a view illustrating the rear surface 3Rb (FIG. 3) of the separator 3 (rear plate 3R) facing the anode electrode 24 on the front surface 2a of a UEA 2, and FIG. 5B is a view illustrating the front surface 3Fa (FIG. 3) of the separator 3 (front plate 3F) facing the cathode electrode 25 on the rear surface 2b of the UEA 2. A region AR1 in the drawing is a region in which power generation is performed by the MEA 20 of the UEA 2 facing the separator 3, and is referred to as an active region (power generation region). A region AR2 outside the active region AR1 (outside in the left-right direction and the up-down direction) is a region in which power generation is not performed, and is referred to as an inactive region (non-power generation region).

As illustrated in FIG. 5A, in the active region AR1 of the separator 3 (rear plate 3R), although not illustrated in full, a plurality of convex portions 31 (FIG. 3) are provided to protrude rearward at equal intervals in the up-down direction over substantially the entire region. Each of the plurality of convex portions 31 extends in the left-right direction, and a concave portion 32 (FIG. 3) is provided between the convex portions 31 and 31 adjacent in the up-down direction. The anode flow path PAa is formed between the plurality of concave portions 32 and the front surface 2a of the MEA 20.

As illustrated in FIG. 5B, in the active region AR1 of the separator 3 (front plate 3F), although not illustrated in full, a plurality of convex portions 31 (FIG. 3) are provided to protrude forward at equal intervals in the up-down direction over substantially the entire region. Each of the plurality of convex portions 31 extends in the left-right direction, and a concave portion 32 (FIG. 3) is provided between the convex portions 31 and 31 adjacent in the up-down direction. The cathode flow path PAc is formed between the plurality of concave portions 32 and the rear surface 2b of the MEA 20.

As illustrated in FIG. 5A, the rear surface 3Rb of the separator 3 (rear plate 3R) is provided with a plurality of sealing bead portions protruding rearward toward the frame 21, that is, metal bead seals, by press molding. The plurality of bead portions include an outer bead portion 331 which extends along the peripheral edge of the rear plate 3R and surrounds the entire through-holes 311 to 316, an inner bead portion 332 which surrounds the through-holes 311 and 316 and the active region AR1 inside the outer bead portion 331, and end bead portions 333 which individually surround the through-holes 312 to 315 between the outer bead portion 331 and the inner bead portion 332. The top of the bead portions 331 to 333 is in close contact with the front surface 2a of the UEA 2 (frame 21), thereby forming a sealed space through which the fuel gas flows from the through-hole 311 to the through-hole 316 via the anode flow path PAa. In order to enhance sealability, a sealing material may be fixed to the top of the bead portions 331 to 333.

As illustrated in FIG. 5B, the front surface 3Fa of the separator 3 (front plate 3F) is provided with a plurality of sealing bead portions protruding forward toward the frame 21, that is, metal bead seals, by press molding. The plurality of bead portions include an outer bead portion 334 which extends along the peripheral edge of the front plate 3F and surrounds the entire through-holes 311 to 316, an inner bead portion 335 which surrounds the through-holes 313 and 314 and the active region AR1 inside the outer bead portion 334, and end bead portions 336 which individually surround the through-holes 311, 312, 315 and 316 between the outer bead portion 334 and the inner bead portion 335. The top of the bead portions 334 to 336 is in close contact with the rear surface 2b of the UEA 2 (frame 21), thereby forming a sealed space through which an oxidant gas flows from the through-hole 314 to the through-hole 316 via the cathode flow path PAc. In order to enhance sealability, a sealing material may be fixed to the top of the bead portions 334 to 336.

As illustrated in FIG. 5A, the inactive region AR2 on the anode side includes a gas flow region AR3 through which the fuel gas flows between the through-holes 311 and 316 and the active region AR1 inside the inner bead portion 332. The separator 3 is provided with a plurality of protrusions 337 having a substantially cylindrical shape protruding toward the UEA 2 on the rear side in the gas flow region AR3. As illustrated in FIG. 5B, the inactive region AR2 on the cathode side includes a gas flow region AR3 through which the oxidant gas flows between the through-holes 313 and 314 and the active region AR1 inside the inner bead portion 335. The separator 3 is provided with a plurality of protrusions 338 having a substantially cylindrical shape protruding toward the UEA 2 on the front side in the gas flow region AR3.

As described above, in the gas flow region AR3 of the separator 3, the plurality of protrusions 337 and 338 are provided toward the UEA 2. Accordingly, in the gas flow region AR3, a reaction gas (fuel gas, oxidant gas) can be equally divided in the up-down direction to flow in the left-right direction. Such a gas flow region AR3 may be referred to as a buffer region, and each of the protrusions 337 and 338 may be referred to as a buffer portion.

The fuel gas flows rightward from the through-hole 311 to the through-hole 316, and the oxidant gas flows leftward from the through-hole 314 to the through-hole 313. Therefore, the fuel cell stack 100 is of a cross-flow type in which a fuel gas and an oxidant gas flow opposite to each other through the UEA 2. Since water is generated on the cathode side, the oxidant gas flowing in the active region AR1 is humidified by the generated water, and the humidity gradually increases in the flow direction (leftward). On the other hand, the generated water diffuses from the cathode side to the anode side through an electrolyte membrane 23 according to a humidity gradient (difference in humidity) with the cathode side. For this reason, the fuel gas is humidified by the generated water by inverse diffusion, and the humidity gradually increases in the flow direction (rightward).

Therefore, the humidity of the fuel gas is higher than the humidity of the oxidant gas in the vicinity of the right end portion of the active region AR1, and the humidity of the oxidant gas is higher than the humidity of the fuel gas in the vicinity of the left end portion. When there is a difference between the humidity of the fuel gas and the humidity of the oxidant gas, moisture moves from a side with a higher humidity to a side with a lower humidity through the electrolyte membrane 23, and the difference in humidity decreases. Such a phenomenon in which the humidity changes is referred to as humidity exchange.

Incidentally, in the power generation cell 1 described above, when the humidity of the reaction gas is excessively low, the movement of protons is suppressed by the drying of the electrolyte membrane 23, and power generation performance is deteriorated. On the other hand, when the humidity is excessively high, the supply of the reaction gas is suppressed, and even in this case, the power generation performance is deteriorated. For this reason, in order to enhance the power generation performance of the power generation cell 1, an appropriate humidity is required for the reaction gas on the anode side and the cathode side.

In this regard, when a through-hole penetrating the frame 21 is provided in the gas flow region AR3 (a region facing the gas flow region AR3 in FIGS. 5A and 5B) of the frame 21 and the humidity exchange between the fuel gas and the oxidant gas is performed through the through-hole, the humidity exchange region is larger than the active region AR1. For this reason, a range in which the humidity is distributed not to be excessively low and not to be excessively high, that is, a range of excellent humidity distribution is expanded, and the power generation performance can be enhanced. However, when the through-hole is provided in the gas flow region AR3 of the frame 21, the strength of the frame 21 decreases. For this reason, there is a possibility that sufficient durability of the UEA 2 cannot be obtained under an environment where a differential pressure acts on the front and rear of the frame 21 and a compressive load F (FIG. 3) acts. In this regard, in order to satisfactorily perform the humidity exchange of the reaction gas while securing sufficient durability, the present embodiment configures the UEA 2 as a membrane electrode structure as follows.

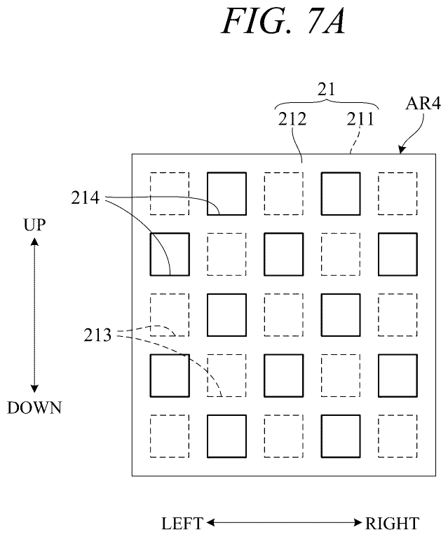

FIG. 6 is a cross-sectional view of the UEA 2 in the vicinity of the inner edge portion 222 of the frame 21 (a cross-sectional view taken along line VI-VI of FIG. 4). The right side of FIG. 6 is the outer edge portion 221 side of the frame 21, and the left side is the center point P side. The outer edge portion 221 side may be referred to as an outer side, and the center point P side may be referred to as an inner side. As illustrated in FIG. 6, the electrode catalyst layer 251 on the cathode side of the UEA 2 extends outward from the electrode catalyst layer 241 on the anode side, and a right end (outer edge 251a) of the electrode catalyst layer 251 is positioned on a right side of a right end (outer edge 241a) of the electrode catalyst layer 241.

The electrolyte membrane 23 extends outward from the electrode catalyst layers 241 and 251, and a right end (outer edge 23a) of the electrolyte membrane 23 is positioned on the right side of the right end of electrode catalyst layers 241 and 251. As indicated by a dotted line in FIG. 4, the electrolyte membrane 23 has a substantially rectangular shape as a whole in plan view as viewed from the stacking direction of the UEA 2. More specifically, the electrolyte membrane 23 extends in the up-down and left-right directions so as to cover the gas flow region AR3 (FIGS. 5A and 5B) on the inner side of the through-holes 201 to 206 in the left-right direction, and the outer edge 23a of the electrolyte membrane 23 is positioned in the vicinity of the inner edge portions of the through-holes 201 to 206 in the horizontal direction. As illustrated in FIG. 6, a right end (outer edge 242a) of the gas diffusion layer 242 on the anode side and a right end (outer edge 252a) of the gas diffusion layer 252 on the cathode side are positioned at the same position as the outer edge 251a of the electrode catalyst layer 251 in the left-right direction. Therefore, the electrolyte membrane 23 protrudes outward from the anode electrode 24 and the cathode electrode 25.

The frame 21 includes a pair of front and rear frames, that is, a front frame 211 and a rear frame 212, which are bonded via an adhesive layer 210. The front frame 211 is bonded to the front surface 23f of the electrolyte membrane 23 via the adhesive layer 210. A left end portion (inner edge portion 222) of front frame 211 extends leftward (inward) from the outer edge 241a of the electrode catalyst layer 241, and is interposed between the electrode catalyst layer 241 and the electrolyte membrane 23. A left end portion (inner edge portion 222) of rear frame 212 extends leftward (inward) from the outer edge 251a of the electrode catalyst layer 251, and is interposed between the electrode catalyst layer 251 and the gas diffusion layer 252. The opening 21a (inner edge) of the front frame 211 is positioned on the left side (inner side) of the opening 21a of the rear frame 212, and the active region AR1 in which the anode electrode 24, the electrolyte membrane 23, and the cathode electrode 25 overlap each other without the frame 21 interposed therebetween is formed on the inner side (left side) of the inner edge of the front frame 211.

The electrolyte membrane 23 is sandwiched between the front frame 211 and the rear frame 212. The portions of the frames 211 and 212 outside the gas diffusion layers 242 and 252 where the electrolyte membrane 23 is sandwiched are referred to as holding portions 215 and 216. In addition, a region where the electrolyte membrane 23 is sandwiched by the holding portions 215 and 216, that is, a region from the outer edges 242a and 252a of the gas diffusion layers 242 and 252 to the outer edge 23a of the electrolyte membrane 23 is referred to as a holding region AR4. The holding region AR4 is included in the inactive region AR2, and a part thereof overlaps the gas flow region AR3 (FIGS. 5A and 5B) between the through-holes 201 to 206 and the active region AR1.

A plurality of through-holes 213 and 214 penetrating the frames 211 and 212 are opened in the holding portions 215 and 216 of the front frame 211 and the rear frame 212, respectively. As illustrated in FIG. 4, the through-holes 213 and 214 are opened over the entire region of the holding region AR4 on the right side in the holding region AR4 on both sides of the opening 21a in the left-right direction, that is, over the entire region of the holding region AR4 on the left side of the through-holes 204 to 206. In FIG. 4, only some through-holes 214 of the rear frame 212 are illustrated for convenience. In addition to the holding region AR4 on the right side or instead of the holding region AR4 on the right side, the through-holes 213 and 214 may be opened over the entire region of the holding region AR4 on the left side.

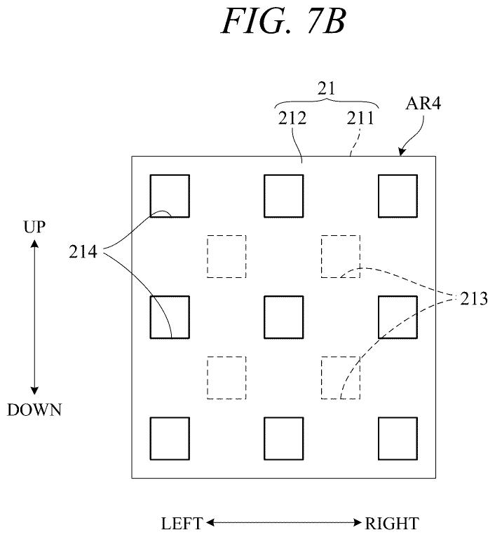

FIG. 7A is a front view (a view taken along an arrow VII of FIG. 4) of a main part of the UEA 2 illustrating the arrangement of the through-holes 213 and 214, and corresponds to a plan view when viewed from the stacking direction of the UEA 2. As illustrated in FIG. 7A, in the holding region AR4 of the frame 21, the through-holes 213 and through-holes 214 which have substantially rectangular shapes are alternately arranged in the left-right direction and the up-down direction. In other words, the through-hole 213 and the through-hole 214 are alternately arranged in the left-right direction and the up-down direction. Therefore, the through-holes 213 and 214 do not overlap each other in plan view. In this case, since the gas diffusion layers 242 and 252 do not need to be provided so as to overlap the through-holes 213 and 214 in plan view, the gas diffusion layers 242 and 252 can be downsized, and the cost can be reduced. By providing the through-holes 213 and 214 in a staggered arrangement in this manner, the strength of the entire frame is improved as compared with a case where the through-holes are provided to overlap each other in plan view from the front surface to the rear surface of the frame 21. Accordingly, the durability of the UEA 2 can be enhanced. In addition, the deformation of the frame 21 can be suppressed, and sufficient sealability between the frame 21 and the bead portions 331 to 336 of the separator 3 can be maintained.

FIG. 6 is a cross-sectional view of the UEA 2 on the upstream side of the oxidant gas (the downstream side of the fuel gas). In the present embodiment, the oxidant gas supply/discharge part 520 is not provided with a humidifier. For this reason, the oxidant gas is supplied to the gas flow region AR3 in a non-humidified state. On the other hand, the fuel gas, after passing through the active region AR1, is humidified by inverse diffusion. For this reason, the humidity of the fuel gas is higher than the humidity of the oxidant gas. Therefore, the moisture contained in the fuel gas moves to the cathode side through the through-hole 213, the electrolyte membrane 23, and the through-hole 214 as indicated by an arrow A in FIG. 6. Accordingly, while the humidity of the oxidant gas increases, the humidity of the fuel gas decreases, and the humidity exchange is performed between the fuel gas and the oxidant gas.

On the other hand, on the upstream side of the fuel gas (on the downstream side of the oxidant gas), the humidity of the oxidant gas is higher than the humidity of the fuel gas as the generated water is generated. However, since the fuel gas is supplied to the gas flow region AR3 in a humidified state via the circulation flow path 510c (FIG. 1), a difference in humidity between the fuel gas and the oxidant gas is smaller than that on the upstream side of the oxidant gas. For this reason, as illustrated in FIG. 4, the through-holes 213 and 214 in the holding region AR4 on the left side can be omitted.

The arrangement and shapes of the through-holes 213 and 214 are not limited to those illustrated in FIG. 7A. For example, as illustrated in FIG. 7B, the through-holes 213 and 214 may be arranged in a staggered manner in the up-down and left-right directions, with their positions (rows and columns) offset in both the up-down and left-right directions. The through-holes 213 and 214 may have a circular shape, an elliptical shape, or a polygonal shape other than the rectangular shape, for example.

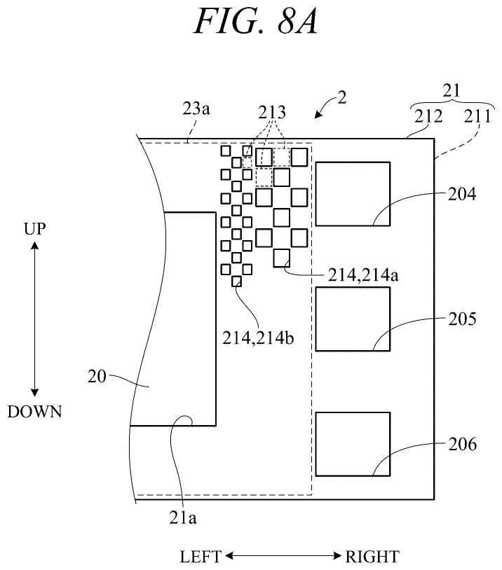

The opening areas of the through-holes 213 and 214 may be changed in the flow direction of the reaction gas instead of being constant over the entire holding region AR4. FIG. 8A is a rear view (a view viewed from the rear) of the UEA 2 as an example of such a configuration. In the example of FIG. 8A, a plurality of through-holes 214 are opened from the through-hole 204 for supplying the oxidant gas of the rear frame 212 to the MEA 20 on the left side thereof. The opening areas of these through-holes 214 gradually decrease from the right side to the left side, that is, from the upstream side to the downstream side of the oxidant gas. Therefore, the opening areas of the through-holes 214a on the right side are larger than the opening areas of the through-holes 214b on the left side.

Although only some of the through-holes 213 are indicated by dotted lines in FIG. 8A, also in the front frame 211, similarly to the through-holes 214, a plurality of through-holes 213 are opened alternately with the through-holes 214 (in a staged manner) such that the opening areas gradually decrease from the right side to the left side. In FIG. 8A, the through-holes 213 and 214 are provided from the through-hole 204 of the frame 21 to the opening 21a, but the vicinity of the through-holes 204 to 206 is on the upstream side of the oxidant gas with respect to the vicinity of the opening 21a. For this reason, the through-holes 213 and 214 may be provided such that the opening areas gradually decrease from the right side to the left side, from the through-holes 204 to 206 to the opening 21a, that is, over the entire holding region AR4.

According to the configuration of FIG. 8A, the humidity exchange between the oxidant gas and the fuel gas on the upstream side of the oxidant gas is promoted. Accordingly, the degree of increase in the humidity of the oxidant gas on the upstream side of the oxidant gas increases, and the degree of decrease in the humidity of the fuel gas increases. As a result, the range in which excellent humidity distribution is obtained can be expanded.

FIG. 8B is a view illustrating a modification of FIG. 8A. In the example of FIG. 8B, the through-holes 213 and 214 is provided such that the opening areas gradually decrease from the vicinity of both end portions of the frame 21 in the up-down direction to the central portion in the up-down direction, that is, from the outside to the inside of the frame 21. Since the through-hole 203 is positioned on the lower left side of the through-hole 204, the oxidant gas flows leftward and downward in the gas flow region AR3. Therefore, also in the example of FIG. 8B, the through-holes 213 and 214 are provided such that the opening areas decrease in the flow direction of the oxidant gas (from the vicinity of the upper end portion to the central portion in the up-down direction). Accordingly, the humidity exchange on the upstream side of the oxidant gas (the downstream side of the fuel gas) is promoted, and the range in which excellent humidity distribution is obtained can be expanded.

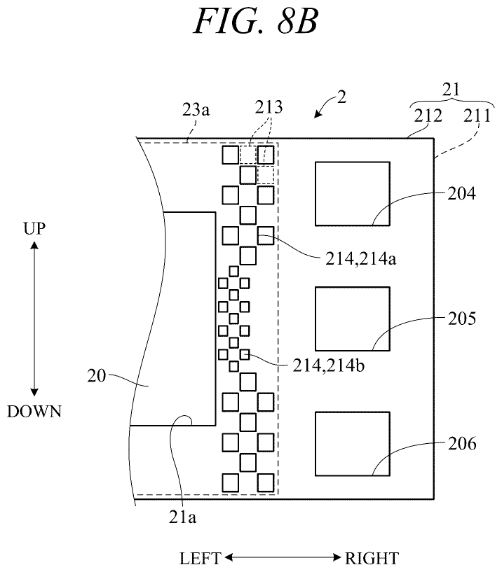

In the above description, the through-holes 213 and 214 are provided in the region between the through-holes 204 to 206 of the frame 21 and the opening 21a in the holding region AR4, but the through-holes 213 and 214 may be provided in another region in the holding region AR4. FIG. 9 is a rear view (a view viewed from the rear) of the UEA 2 as an example of such a configuration. In the example of FIG. 9, a plurality of through-holes 214 are provided between the through-holes 204 and 205 adjacent in the up-down direction of the rear frame 212. Similarly, the front frame 211 is also provided with a plurality of through-holes 213 alternately with the through-holes 214, more specifically, in a staggered manner, between the through-holes 204 and 205.

The plurality of through-holes 213 and 214 can be provided not only between the through-holes 204 and 205 but also between the through-holes 205 and 206. The through-holes 213 and 214 may be provided not only between the through-holes 204 and 205 but also in a region between the through-holes 204 to 206 and the opening 21a similarly to FIGS. 7A to 8B. In FIG. 9, the outer edge 23a of the electrolyte membrane 23 is positioned outside the through-holes 201 to 206. Further, in the electrolyte membrane 23, in addition to the opening 21a, openings 231 to 236 are provided by punching or the like corresponding to the positions and shapes of the through-holes 201 to 206. According to the configuration of FIG. 9, the through-holes 213 and 214 are positioned further outward in the left-right direction than those of FIGS. 7A to 8B, and thus the humidity exchange range in the holding region AR4 is enlarged in the left-right direction. Accordingly, the range in which excellent humidity distribution is obtained can be expanded.

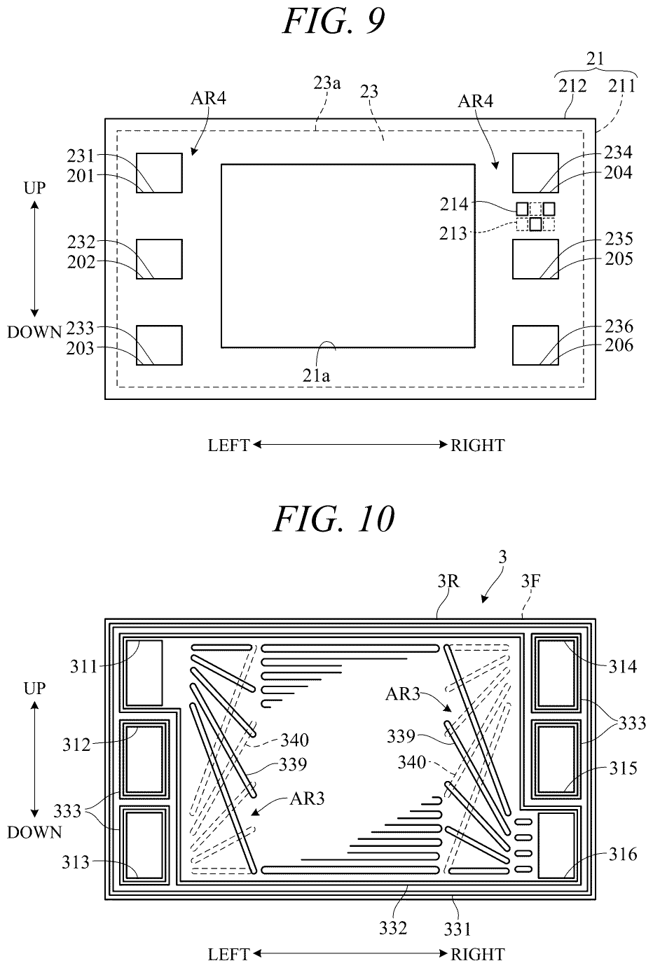

In the above description, the buffer portion is configured by providing the substantially cylindrical protrusions 337 and 338 in the gas flow region AR3 of the separator 3 (FIGS. 5A and 5B), but the configuration of the buffer portion is not limited to that described above. FIG. 10 is a rear view (a view viewed from the rear) of the separator 3 having another buffer portion. As illustrated in FIG. 10, on the rear surface 3Rb of the separator 3 (rear plate 3R), a plurality of elongated convex portions 339 are provided to protrude along the flow direction of the fuel gas on both sides of the active region AR1 in the left-right direction.

More specifically, the plurality of convex portions 339 on the left side extend rightward or diagonally downward to the right such that the flow path areas gradually increase from the through-hole 311 for supplying the fuel gas to the inlet (left end portion) of the active region AR1, and the gas flow region AR3 has a substantially trapezoidal shape in plan view. Further, the convex portion 339 on the right side extends rightward or diagonally downward to the right side such that the flow path areas gradually decrease from the outlet (right end portion) of the active region AR1 to the through-hole 316 for discharging the fuel gas, and the gas flow region AR3 has a substantially trapezoidal shape in plan view.

Similarly, on the front surface 3Fa of the separator 3 (front plate 3F), a plurality of elongated convex portions 340 are provided to protrude along the flow direction of the oxidant gas on both sides of the active region AR1 in the left-right direction. More specifically, the plurality of convex portions 340 on the right side extend leftward or diagonally downward to the left such that the flow path areas gradually increase from the through-hole 314 for supplying the oxidant gas to the inlet (right end portion) of the active region AR1, and the gas flow region AR3 has a substantially trapezoidal shape in plan view. The convex portion 340 on the further left side extends leftward or diagonally downward to the left such that the flow path areas gradually decrease from the outlet (left end portion) of the active region AR1 to the through-hole 313 for discharging the oxidant gas, and the gas flow region AR3 has a substantially trapezoidal shape in plan view.

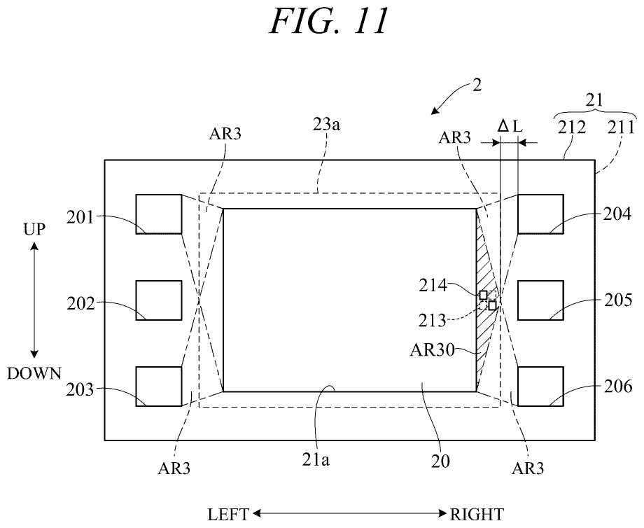

FIG. 11 is a front view (a view viewed from the rear) of the UEA 2 facing the separator 3 in FIG. 10. As illustrated in FIG. 11, in the frame 21 of the UEA 2, the through-holes 213 and 214 are opened in a region (a hatched region AR30 in FIG. 11) where the gas flow region AR3 on the anode side (the rear surface side of the separator 3) and the gas flow region AR3 on the cathode side (the front surface side of the separator) overlap each other. In this case, the right end portion of the electrolyte membrane 23 is positioned leftward of the through-holes 204 to 206 by a predetermined length ΔL. Accordingly, the electrolyte membrane 23 can be shortened in the left-right direction, and the cost can be reduced.

According to the present embodiment, the following operations and effects are achievable.
(1) The UEA 2 as a membrane electrode structure for a fuel cell includes: the membrane electrode assembly (MEA) 20 formed by stacking the electrolyte membrane 23, the anode electrode 24 arranged on the front surface 23f of the electrolyte membrane 23, and the cathode electrode 25 arranged on the rear surface 23r of the electrolyte membrane 23; and the frame 21 having the inner edge portion 222 defining the opening 21a in which the MEA 20 is disposed (FIGS. 3 and 4). The frame 21 includes the front frame 211 and the rear frame 212, each having the inner edge portion 222, and the front frame 211 and the rear frame 212 overlap each other and are substantially plate shaped (FIG. 6). The electrolyte membrane 23 extends to the inactive region AR2 (non-power generation region) outside the outer edges 241a and 242a of the anode electrode 24 and the outer edges 251a and 252a of the cathode electrode 25 (FIG. 6). The front frame 211 and the rear frame 212 have the holding portions 215 and 216 that sandwich the electrolyte membrane 23 in the inactive region AR2, respectively. In the holding portions 215 and 216, the through-hole 213 penetrating the holding portion 215 and the through-hole 214 penetrating the holding portion 216 are provided at different positions in plan view as viewed from the stacking direction of the MEA 20, respectively (FIGS. 6, 7A, and 7B).

By opening the through-holes 213 and 214 at different positions of the pair of frames 211 and 212 sandwiching the electrolyte membrane 23 in this manner, the strength of the frame 21 capable of humidity exchange via the electrolyte membrane 23 in the inactive region AR2 is improved. Accordingly, it is possible to satisfactorily perform the humidity exchange between the fuel gas and the oxidant gas while securing sufficient durability of the UEA 2. In addition, since the electrolyte membrane 23 of the MEA 20 protrudes outward from the anode electrode 24 and the cathode electrode 25 of the MEA 20 and is sandwiched, the electrodes 24 and 25 can be downsized, and the cost can be reduced.
(2) The through-holes 213 and the through-holes 214 are provided at the holding portions 215 and 216 in a staggered arrangement in plan view (FIGS. 7A and 7B). Accordingly, the through-holes 213 and 214 are not positioned to overlap each other in plan view, and the durability of the UEA 2 can be improved.
(3) The frame 21 is provided with the through-holes 201, 203, 204, and 206 through which a reaction gas flows (FIG. 4). The inactive region AR2 includes the gas flow region AR3 through which the reaction gas flows between the through-holes 201, 203, 204, and 206 and the active region AR1 (power generation region) in which the electrolyte membrane 23, the anode electrode 24, and the cathode electrode 25 are stacked (FIGS. 5A and 5B). The through-holes 213 and 214 are provided in the gas flow region AR3 (FIG. 6). Since generated water is generated according to the flow of the reaction gas, the humidity changes along the flow direction of the reaction gas, but by providing the through-holes 213 and 214 in the gas flow region AR3, the humidity exchange can be satisfactorily performed in a region where the difference in humidity is large.
(4) The through-holes 201, 203, 204, and 206 include the through-holes 201 and 206 for supplying the fuel gas and for discharging fuel gas through which the fuel gas flows, and the through-holes 204 and 203 for supplying the oxidant gas and for discharging oxidant gas through which the oxidant gas flows (FIG. 4). The gas flow region AR3 includes the gas flow region AR3 (a first gas flow region), through which the fuel gas flows, between the through-holes 201 and 206 on the anode side and the active region AR1, and the gas flow region AR3 (a second gas flow region), through which the oxidant gas flows, between the through-holes 204 and 203 on the cathode side and the active region AR1 (FIGS. 5A and 5B). The through-holes 213 and 214 are provided in the region AR30 where the gas flow regions AR3 on the anode side and the cathode side overlap each other in plan view (FIG. 11). Accordingly, the electrolyte membrane 23 can be downsized, and the cost can be reduced.
(5) The through-holes 213 and 214 each are a plurality of through-holes provided in the gas flow region AR3 (FIGS. 8A and 8B). The plurality of through-holes 213 and the plurality of through-holes 214 are provided such that the opening areas decrease in the flow direction of the reaction gas (FIGS. 8A and 8B). Accordingly, the humidity exchange on the upstream side in the flow direction of the reaction gas is promoted, and the range in which excellent humidity distribution is obtained can be expanded.
(6) The frame 21 is provided with a plurality of through-holes 201 to 206 through which the reaction gas and the cooling medium flow (FIG. 4). The through-holes 213 and 214 are provided between a pair of adjacent through-holes 204 and 205 among the plurality of through-holes 201 to 206 (FIG. 9). Accordingly, since the through-holes 213 and 214 are positioned further outward in the left-right direction, the humidity exchange range in the holding region AR4 is enlarged in the left-right direction, and the range in which excellent humidity distribution is obtained can be expanded.
(7) The gas flow region AR3 is formed such that the flow direction of the fuel gas facing the front frame 211 and the flow direction of the oxidant gas facing the rear frame 212 are opposite to each other (FIG. 6). That is, the gas flow region is configured as a cross-flow type. Accordingly, the through-holes 213 and 214 are provided in a region where the difference in humidity between the fuel gas and the oxidant gas is large, and the humidity exchange can be effectively performed.
(8) The gas flow region AR3 includes the gas flow region AR3 on a left side and the gas flow region AR3 on a right side with the electrolyte membrane 23 interposed therebetween, the gas flow region AR3 on the left side being on the upstream side in the flow direction of the fuel gas and on the downstream side in the flow direction of the oxidant gas and the gas flow region AR3 on the right side being on the downstream side in the flow direction of the fuel gas and on the upstream side in the flow direction of the oxidant gas (FIGS. 4, 5A, and 5B). The through-holes 213 and 214 are not provided in the gas flow region AR3 on the left side of these gas flow regions AR3, but are provided in the gas flow region AR3 on the right side (FIG. 4). Accordingly, a region where the through-holes 213 and 214 for humidity exchange are provided is minimized, and sufficient strength of the UEA 2 can be maintained.
(9) The fuel cell system 500 includes the fuel cell stack 100 formed by stacking the power generation cells 1 each having the above-described UEA 2 (FIG. 1). The fuel cell system 500 further includes the circulation flow path 510c and the ejector 513 as a gas returning part that returns the fuel gas flowing out of the fuel cell stack 100 to the fuel cell stack 100 (FIG. 1). Accordingly, since the fuel gas is supplied to the fuel cell stack 100 in a humidified state through the circulation flow path 510c, it is not necessary to actively humidify the fuel gas by the generated water of the oxidant gas, and the through-hole (the through-hole on the left side of the frame 21) for humidity exchange on the upstream side of the fuel gas can be omitted.

The above embodiment can be modified in various forms. Below, some modified examples are described. In the above embodiment, the holding portion 215 (a first holding portion) of the front frame 211 (a first frame member) and the holding portion 216 (a second holding portion) of the rear frame 212 (a second frame member) constituting the frame 21 as a frame member are provided with through-holes 213 (a first through-hole) and 214 (a second through-hole) so as not to overlap each other in a plan view, but part of the first through-hole and the second through-hole may overlap in the plan view. In this case, it is preferable that part of the through-holes overlap in a relatively rigid area, such as the central portion of the holding region AR4.

In the above embodiment (FIGS. 4, 6 to 9 and 11), the through-holes 213 and 214 for humidity exchange are provided on the right side of the opening 21a of the frame 21 (upstream side of the oxidant gas and downstream side of the fuel gas), but instead of or in addition to this configuration, through-holes for humidity exchange may be provided on the left side of the opening 21a (downstream side of the oxidant gas and upstream side of the fuel gas). In the above embodiment, the through-holes 201, 203, 204 and 206 as a communication hole through which a reaction gas flows are provided in the frame 21. More specifically, the through-holes 201 and 206 (a first communication hole) through which the fuel gas as a first reaction gas flows, and the through-holes 203 and 204 (a second communication hole) through which the oxidant gas as a second reaction gas flows, are provided in the frame 21, but the position, number, shape, and arrangement of these communication holes are not limited to those described above.

In the above embodiment, the first reaction gas is the fuel gas (anode gas), and the second reaction gas is the oxidant gas (cathode gas), but the first reaction gas may be the oxidant gas and the second reaction gas may be the fuel gas, and the configuration of the first and second reaction gases is not limited to those described above. In the above embodiment (FIG. 9), a plurality of through-holes 201 to 206 (communication holes) through which a reaction gas and cooling medium flow are provided in the frame 21, and through-holes 213 and 214 are provided between a pair of through-holes 204 and 205 (a pair of communication holes) arranged adjacent to each other, but the through-holes 213 and 214 for humidity exchange may also be provided between another pair of through-holes arranged adjacent to each other.

In the above embodiment, the anode electrode 24 (a first gas diffusion electrode layer) is provided on the front surface 23f (a first surface) of the electrolyte membrane 23, and the cathode electrode 25 (a second gas diffusion electrode layer) is arranged on the rear surface 23r (a second surface), but the cathode electrode 25 may be provided on the front surface 23f and the anode electrode 24 on the rear surface 23r.

In the above embodiment, an example of applying the fuel cell stack 100 to a vehicle is described, but a fuel cell stack having a membrane electrode structure for a fuel cell of the present invention can also be applied to various industrial machines in addition to a moving body other than a vehicle such as an aircraft or a boat, a robot, and the like.

The above embodiment can be combined as desired with one or more of the above modifications. The modifications can also be combined with one another.

According to the present invention, it is possible to achieve efficient gas humidity exchange while ensuring sufficient durability.

Above, while the present invention has been described with reference to the preferred embodiments thereof, it will be understood, by those skilled in the art, that various changes and modifications may be made thereto without departing from the scope of the appended claims.

What is claimed is:

1. A membrane electrode structure for a fuel cell comprising:
a membrane electrode assembly including an electrolyte membrane, a first gas diffusion electrode layer provided on a first surface of the electrolyte membrane, and a second gas diffusion electrode layer provided on a second surface of the electrolyte membrane opposite to the first surface, the electrolyte membrane, the first gas diffusion electrode layer and the second gas diffusion electrode layer being stacked in a predetermined direction; and
a frame member including an inner edge portion defining an opening, the membrane electrode assembly being positioned to face the opening, wherein
the frame member includes a first frame member and a second frame member formed in a substantially plate shape and overlapping each other,
each of the first frame member and the second frame member includes the inner edge portion,
the electrolyte membrane is extended to a non-power generation region outside an outer edge of the first gas diffusion electrode layer and outside an outer edge of the second gas diffusion electrode layer,
the first frame member and the second frame member have a first holding portion and a second holding portion, respectively, so as to sandwich the electrolyte membrane in the non-power generation region between the first holding portion and the second holding portion,
a first through-hole and a second through-hole are provided to penetrate the first holding portion and the second holding portion, respectively, and
a position of the first through-hole is different from a position of the second through-hole in a plan view when viewed along the predetermined direction.

2. The membrane electrode structure according to claim 1, wherein
the first through-hole and the second through-hole are provided at the first holding portion and the second holding portion in a staggered arrangement in the plan view.

3. The membrane electrode structure according to claim 1, wherein
a communication hole through which a reaction gas flows is provided at the frame member,
the non-power generation region includes a gas flow region through which the reaction gas flows,
the gas flow region is positioned between the communication hole and a power generation region where the electrolyte membrane, the first gas diffusion electrode layer and the second gas diffusion electrode layer are stacked, and
the first through-hole and the second through-hole are provided in the gas flow region.

4. The membrane electrode structure according to claim 3, wherein
the reaction gas includes a first reaction gas and a second reaction gas,
the communication hole includes a first communication hole through which the first reaction gas flows and a second communication hole through which the second reaction gas flows,
the gas flow region includes a first gas flow region where the first reaction gas flows and a second gas flow region where the second reaction gas flows,
the first gas flow region is formed between the first communication hole and the power generation region on a side of the first gas diffusion electrode layer,
the second gas flow region is formed between the second communication hole and the power generation region on a side of the second gas diffusion electrode layer, and
the first through-hole and the second through-hole are provided in a region where the first gas flow region and the second gas flow region overlap each other in the plan view.

5. The membrane electrode structure according to claim 3, wherein
the first through-hole includes a plurality of first through-holes provided in the gas flow region,
the second through-hole includes a plurality of second through-holes provided in the gas flow region, and
the plurality of first through-holes and the plurality of second through-holes are provided so that opening areas of the plurality of first through-holes and the plurality of second through-holes decrease in a flow direction of the reaction gas.

6. The membrane electrode structure according to claim 1, wherein
a plurality of communication holes through which a reaction gas and a cooling medium flow, and
the first through-hole and the second through-hole are provided between a pair of communication holes disposed adjacent to each other among the plurality of communication holes.

7. The membrane electrode structure according to claim 3, wherein
the reaction gas includes a first reaction gas flowing facing the first frame member and a second reaction gas flowing facing the second frame member, and
a flow direction of the first reaction gas in the gas flow region is opposite to a flow direction of the second reaction gas in the gas flow region.

8. The membrane electrode structure according to claim 7, wherein
the gas flow region includes a first side gas flow region on one outside of the electrolyte membrane and a second side flow region on another outside of the electrolyte membrane,
the first side gas flow region is a region on an upstream side in the flow direction of the first reaction gas and on a downstream side in the flow direction of the second reaction gas,
the second side gas flow region is a region on a downstream side in the flow direction of the first reaction gas and on an upstream side in the flow direction of the second reaction gas, and
the first through-hole and the second through-hole are provided in the second side gas flow region, without being provided in the first side gas flow region.

9. The membrane electrode structure according to claim 8, wherein
the first reaction gas is an anode gas and the second reaction gas is a cathode gas.

10. A fuel cell system comprising
a fuel cell stack configured by stacking a plurality of power generation cells, wherein
each of the plurality of power generation cells includes the membrane electrode structure according to claim 3,
the reaction gas is an anode gas, and
the fuel cell system further comprising
a gas recirculation part configured to recirculate the anode gas flowing out from the fuel cell stack into the fuel cell stack.
